(19) United States
(12) Patent Application Publication
(10) Pub. No.: US 2006/0155614 A1
(43) Pub. Date: Jul. 13, 2006

(54) Method and Apparatus for Selling Consumer Products Using High Resolution Images

(75) Inventors: Dwight Woytowick, Wellesley, MA (US); Matthew Hodges, Wellesley, MA (US)

Correspondence Address: LOWRIE, LANDO & ANASTASI, RIVERFRONT OFFICE, ONE MAIN STREET, ELEVENTH FLOOR, CAMBRIDGE, MA, 02142, US

(73) Assignee: VPRO INC., Wellesley, MA (US)

(21) Appl. No.: 11/163,168

(22) Filed: Oct. 7, 2005

Related U.S. Application Data
(60) Provisional application No. 60/593,441, filed on Jan. 14, 2005.
(60) Provisional application No. 60/616,732, filed on Oct. 7, 2004.

(51) Int. Cl. G06Q 30/00

(52) U.S. Cl. 705/27; 705/26

(57) ABSTRACT

Disclosed are a method and apparatus for collecting information about vehicles. Also disclosed are a method and apparatus for making a market in used vehicles. The method includes collecting image data depicting a vehicle for sale in sufficient detail that visual imperfections are evident in the images when displayed using scan and zoom functions; collecting non-image vehicle data further characterizing the vehicle for sale; compiling the collected data into a searchable database; receiving from a customer a query defining a desired vehicle; displaying data to the customer responsive to the query; selecting a vehicle responsive to an input by the customer; shipping the selected vehicle from a dealer remote from the customer to a dealer local to the customer; and completing a transaction involving the vehicle at the dealer local to the customer. The apparatus includes one or more computers configured and connected to collect, store and display image data depicting a vehicle for sale in sufficient detail that visual imperfections are evident in the images when displayed using scan and zoom functions; collect, store and display non-image vehicle data further characterizing the vehicle for sale; compile the collected data into a searchable database; receive from a customer a query defining a desired vehicle; display data to the customer responsive to the query; select a vehicle responsive to an input by the customer; ship the selected vehicle from a dealer remote from the customer to a dealer local to the customer; and complete a transaction involving the vehicle at the dealer local to the customer.

### BACKGROUND

The invention relates generally to technology for sharing information about vehicles, for example in connection with sales, insurance, maintenance, registration and other processes. For example, the technology is useful for getting vehicle buyers and sellers together virtually, even though they may be physically widely separated. Buyers can view images and data pertaining to a particular vehicle for sale, permitting the buyer to evaluate the offer price of the vehicle in relation to the condition of the vehicle.

Soon after mass marketing of the first automobiles began, a market in used vehicles sprang up; as did the legend of the used car salesperson and the phrase, “have I got a deal for you.” Savvy buyers soon realized that in order to make a wise purchase, they needed to examine a vehicle on offer carefully for its condition. Such an examination could, of course, only take place “in person.” If the buyer was unable to personally examine the vehicle, the only alternative was to hire a trustworthy agent who could personally examine the vehicle.

As vehicles proliferated, a wholesale market in used vehicles also developed. The wholesale market exhibited similar characteristics to the retail used vehicle market, but with some added complications. For example, at wholesale, vehicles began to be sold at auction. Dealers would take vehicles in trade, and then be unable to resell them at retail. Those vehicles would then be auctioned to other used vehicle dealers, who might be in other geographic markets or who might be in a better position to restore and retail a vehicle that exhibited some problems.

Although many characteristics, advantages and disadvantages of these early market models persist to the present time, yet more variations and complications have appeared, as are now discussed.

The current market is heavily fragmented by many wholesale transactions, including transactions between leasing and finance companies and dealers, manufacturers and dealers (e.g. brass hats and program vehicles), dealers and wholesalers, wholesalers and auction houses, auction houses and dealers, auction houses and wholesalers, wholesalers and dealers and finally, dealers and retail consumers. Some of these transactions occur within geographically local regions, while some occur between geographically separated regions. Regionalization fragments the market further by creating local supply and demand imbalances.

In order to redistribute vehicles from a geographic market of low demand to one of high demand, auctions are still used. A great deal of condition information is collected about vehicles in both public and private data collections. Public collections of data about automobiles, one type of vehicle of interest, include police reports, registration records and the like. Some public records are accessible from services like CARFAX.com, for example. Private collections of data include service data collected by service departments of vehicle dealers, fleet maintenance records, as-built records and the like. Presently, only a small fraction of the condition data actually collected about a particular vehicle is actually available to the consumer at the wholesale or retail level. As a result, consumers at both the wholesale and retail levels tend to restrict their searches for suitable vehicles to purchase to geographic market areas that are sufficiently proximate that they or their trusted agents can physically examine each target vehicle, a time-consuming and expensive process mentioned above.

An example situation is now described in which a New England consumer in winter trades a convertible in for a pre-owned 4×4. Because this example takes place in winter in New England, the consumer may receive a reduced, and disappointing, value for the convertible, which is in low demand at such a time and place. Alternatively, the dealer may over-allow on the trade, reducing the dealer's front-end gross profit. Finally, in either case, the dealer then must wait for convertible season in New England or wholesale the convertible in order to maximize the recovered value.

In the more common scenario, the dealer will wholesale the vehicle, rather than carry the inventory. Some rough numbers are now applied to the trade. Typically, the dealer wholesales the convertible for about $500 profit. Little or no work is performed by the dealer shop. The wholesaler then sells the convertible at auction for a $2,000 profit. The auctioneer, meanwhile, collects transaction fees of about $1,000 each from the buyer and the seller. The total markup on the vehicle has been $4,500, from trade to final buyer, but the dealer has only made $500 profit. The dealer has lost $4,000 of markup to inefficiencies in the market. Moreover, these figures do not include the multiple shipping steps that must occur to get the vehicle to the middleman who performs each intermediate stage of the process.

If a retail consumer is willing to restrict their search to a relatively local geographic market, they can automate the process somewhat by utilizing services such as offered by Cars.com, Vehix.com, Autobytel, newspaper web sites and other classified and auction sites. Such services show the cars, perhaps including images of the actual vehicles offered, in incomplete fashion, giving the consumer access to publicly available data, for example by offering a link to Carfax.com, or the like, so the consumer can at additional cost obtain the publicly available data.

When vehicles are shown this way, the consumer receives incomplete condition information, at best. The publicly available data is inherently incomplete because the dealer networks and manufacturers do not share information with the public. Moreover, images placed on the sites mentioned are generally provided by the seller and have low resolution. As a result, defects that could be found and evaluated visually by a personal inspection by the consumer are often obscured or unidentifiable in the images, either intentionally or due to the limitations inherent in the limited number of images such sites permit.

Also, as a result of the limitations on the present art mentioned above, transactions between remote geographic markets are unlikely. Thus, the present market system does not solve the problem of redistributing vehicles from a market in which the particular vehicle is in low demand to a market in which the particular vehicle is in high demand.

In the fields of insuring and registering vehicles, as well as in vehicle sales, it is often desirable to have or obtain a record of the history of a vehicle's condition. A vehicle's condition may change as a result of after-market upgrades, additions or deletions, or accidents and repairs. Subsequent insurance coverage, registration or purchase transactions desirably would take such history into account; however, history information today is found in scattered locations and cannot be readily correlated. Particularly vexing is the need to make a special effort to have photos taken to document a vehicle's cosmetic or external structural condition, for example when a used vehicle changes hands.

### SUMMARY OF THE INVENTION

What is desired is an improved method and apparatus for marketing vehicles.

The proposed business method includes a method and apparatus for collecting high resolution images of a vehicle, including both interior and exterior images when appropriate. The proposed method further includes a method and apparatus for merging the high resolution image data with other data from sources such as public databases, private databases, government databases and the manufacturer. The other data may include further images, text or numerical data detailing history, accessories, condition and other information pertinent to the particular vehicle on offer. The other data may include detailed, certified condition data compiled and provided by the manufacturer, a dealer, or other private or public source. All of the images and data may be keyed to the vehicle identification number (VIN in the case of automobiles, HIN in the case of boats, etc.) of the particular vehicle on offer. The term “vehicle identification number” is used herein in its most general sense, encompassing VIN, HIN and other character strings by which a particular vehicle is identified.

The high resolution images may be collected using plural exterior image capture devices that may be portable, or may be set up in studio conditions. Collected exterior images are transferred to a central processor which compiles them into still frame views and a navigable, exterior panoramic view. Interior images may be collected using a panoramic image capture device that is portable and temporarily mounted to the interior of the vehicle.

Image and data capture, including set-up time is about 5-6 minutes using this method.

Using the method, a buyer views vehicle images and data on a display screen. When the buyer settles on a vehicle purchase, the buyer indicates the choice to a local dealer. The viewing and indicating may take place at the local dealership or elsewhere. The local dealer then contacts the owner-dealer of the vehicle, which may be remote from the buyer. The vehicle is then shipped to the local dealer, who completes the transaction with the buyer.

Advantages of this method and apparatus include the buyer's greater assurance of receiving accurate condition information regarding many vehicles, including those remote from the buyer, a more liquid market in used vehicles due to not needing to move vehicles in or out of geographic locations in an attempt to find the “hot” market—vehicles are moved when they are desired at a location, low cost of advertising vehicles and access to the wider market by independent dealers.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a schematic block diagram of an internet-based market system according to aspects of some embodiments of the present invention;

FIG. 2 is a schematic block diagram of an internet-based market system according to further aspects of some embodiments of the present invention;

FIG. 3 is a flow diagram of a method according to yet further aspects of some embodiments of the invention;

FIG. 4 is a schematic block diagram of a circumnavigational imaging system according to aspects of some embodiments of the present invention;

FIG. 5 is a schematic block diagram of a central processor of the circumnavigational imaging system of FIG. 3;

FIG. 6 is a schema for a database used in accordance with aspects of some embodiments of the circumnavigational imaging system of FIGS. 3 and 5;

FIG. 7 is a flow diagram of a method of operating the system of FIGS. 4-6;

FIG. 8 is a flow diagram of a method of operating the system of FIGS. 4-6;

FIG. 9 is a flow diagram of a method of operating the system of FIGS. 4-6;

FIG. 10 is a schematic block diagram of a computer system suitable for embodying various aspects of the present invention; and

FIG. 11 is a schematic block diagram of the storage subsystem of the computer system of FIG. 10.

### DETAILED DESCRIPTION

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” or “having,” “containing”, “involving”, and variations thereof herein, is meant to encompass the items listed thereafter and equivalents thereof as well as additional items.

In accordance with some aspects of embodiments of the invention, automobiles, trucks, motorcycles, boats, aircraft and other transportation vehicles are brought to market via the internet. According to one business model, an internet-based market is provided as a service to manufacturers, fleet companies, dealers, rental agencies and banks in exchange for a monthly subscription fee collected.

Aspects of some embodiments of the invention have been described in prior provisional applications to which domestic priority has been claimed for this application. Provisional U.S. patent application Ser. No. 60/616,732, filed Oct. 7, 2004, and entitled SYSTEM FOR PRODUCING CIRCUMNAVIGATIONAL IMAGES OF PHYSICAL OBJECTS describes aspects of imaging technology useful in connection with the invention, and provisional U.S. patent application Ser. No. 60/593,441, filed Jan. 14, 2005, and entitled METHOD AND APPARATUS FOR SELLING CONSUMER PRODUCTS USING HIGH RESOLUTION IMAGES describes other useful aspects of embodiments of the invention. Both provisional U.S. patent application Ser. No. 60/616,732 and provisional U.S. patent application Ser. No. 60/593,441 are incorporated herein in their entirety by reference.

Images are captured of vehicles using circumnavigational imaging technology, described in greater detail below. In brief, plural high-resolution images are edited and stitched together into a viewer-controlled virtual tour of the exterior and interior of the vehicle. A viewer, for example a potential buyer, can zoom in on selected areas of the vehicle for a close inspection that will prevent the seller from hiding imperfections in the vehicle. The complete process of taking the pictures and posting them to a hosting site on the internet takes less than 5 minutes.

The internet-based market can be operated across brand, fleet, dealer affiliation, etc., lines, if desired. Alternatively, each manufacturer or other selling unit can maintain their own channel or site, for example, in conjunction with an existing site that will give them the ability to control the flow of off-lease vehicles and fleet vehicles that are returned either to their dealers or directly from the rental companies.

It is intended that the software system embodying the internet-based market can link into the manufacturer's and other proprietary databases to retrieve effective data needed to give a full and comprehensive history of the vehicle and its optional equipment, unique to that specific vehicle. That is, initial condition data is compiled to create a virtual window sticker or build sheet based on the vehicle identification number. Transfer of this data can occur while the photos are taken and be linked directly to the profile of the vehicle. At the same time, a report, or the like can also be generated from the vehicle identification number and included in the data file.

A dealer receiving a vehicle for listing, or listing one of their own vehicles, in the internet-based market will perform a certification inspection as is conventionally done by franchised new and used car dealers. The raw input data and/or the resulting report can be processed via a personal digital assistant (PDA) device or other portable data-gathering device to eliminate paper from the process that is now in place. This data is integrated with the above-described virtual tour and other data that is collected. The result is a comprehensive history of the vehicle starting with the vehicle's as-built specifications, and ending with the current condition, including visual aspects. Optionally, the data available on any particular vehicle, or structurally designed to be available in the system can be made more or less detailed than described herein, as may be desired.

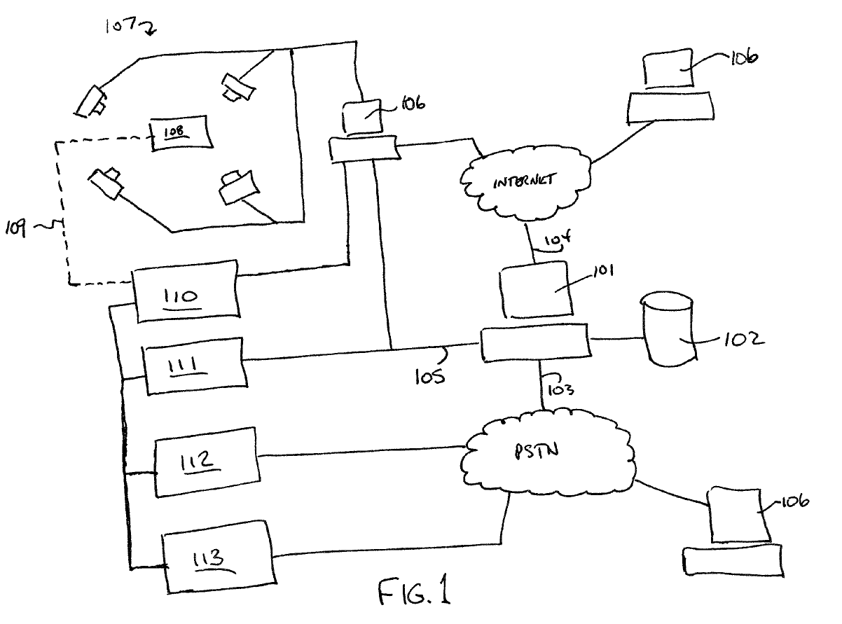

The system may be organized as shown in FIG. 1, now described.

The system may include one or more host computers 101 having access to a common database 102 in which listed vehicles, vehicle status and other pertinent data are stored. The host computer 101 may be connected to other components of the system through any suitable communication link including the public switched telephone network (PSTN) 103, the internet 104 and private connections 105. Users of the system including consumers, dealers and others can communicate with the host computer 101 using any suitable workstation 106. At least one workstation 106 may be a part of a circumnavigational imaging system 107 that captures circumnavigational images of vehicle 108. A vehicle identification number 109 is used to identify image data and other data concerning vehicle 108 in a database 110 associated with the circumnavigational imaging system 107, as well as other databases 111, 112 and 113 that may hold data relevant to the vehicle condition, as explained above. The data related through the vehicle identification number 109 to the vehicle 108 may be transferred through the workstation operating the circumnavigational imaging system 107 or other channels (as shown) to the host computer 101, wherein the data is merged into the database 102.

The system includes an open interface to handle input from individuals and from non-franchised dealers which are then integrated into a total market including vehicles that are channeled from the manufacturers and franchised dealer networks that presently exist. This non-franchised dealer population represents approximately 80 percent of the selling and buying market on the wholesale level.

To find a vehicle on the market, search criteria are input to a search engine which then locates matching vehicles in the database.

Once a transaction is undertaken, the banking or transfer of funds after the title has been transferred to the buyer can be effected by the internet-based market system software, by a trusted third-party payment system such as Paypal, by a trusted escrow and transfer agent operating on the internet, or the like.

A consumer-oriented user interface to the internet-based market system is presented to consumers from the general public or other dealerships. This interface will give a consumer detailed information about a desired vehicle of their choice, but withhold from them the vehicle's physical location. Thus, use of the market leads the consumer to a local retail dealer in their market area to choose from, who will handle the transaction and benefit thereby. These dealers will have a “customer satisfaction rating” or scorecard to help guide the consumer in choosing the dealer which best meets their needs. This interface may include various suitable e-commerce features, such as a shopping cart, payment and delivery systems.

The consumer browses or searches for one or more vehicles to purchase using conventional e-commerce techniques. Vehicles have associated status indications, for example, including “available,” or “hold” or “sold.” The consumer may browse or search for vehicles matching particular status conditions.

The consumer selects a convenient dealer and moves the vehicle to the shopping cart by any suitable technique. The system may optionally provide means for the consumer to select financing options and warrantee options that are available, or other add-on services available at the dealer selected. At this point, the selected dealer and the current owner or owner-dealer are each notified of the purchase and that there is a pending “deal” waiting for financial approval. That vehicle is then moved into a “hold” status until the financial approval is cleared. After approval the vehicle is then dispatched from the owner or owner-dealer to a carrier dispatching service for shipment to the dealer and prepared for delivery.

In the case that there are transportation issues or issues concerning the vehicle's condition necessitating arbitration or other compensation or settlement, the entire transaction can be readily reversed, as follows. The vehicle status can be changed back to “available” and the transaction reversed. It is then up to the manufacturer or originating dealer to remove the vehicle from the internet-based market and dispose of the vehicle thru existing wholesale channels, e.g. auctions or wholesaling, or the originating dealer can pay the selected dealer to hold the vehicle on their lot until it is again sold, or the receiving dealer can purchase the vehicle for their own inventory.

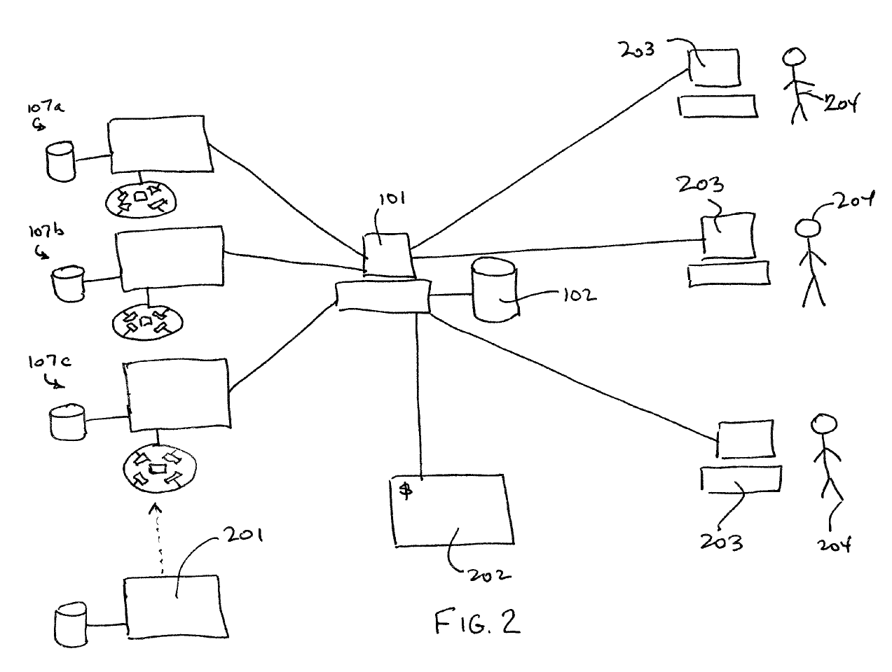

In a contemplated configuration, shown in FIG. 2, the host computer 101 is connected to plural circumnavigational imaging systems 107a, 107b and 107c. These may be conveniently located at franchised dealerships, for example, dealerships that regularly receive vehicles in trade, or may be portable systems that are moved to required locations as desired. In this configuration, the circumnavigational imaging systems 107a, 107b and 107c are used to perform all the data entry and data transfer requests required to list a vehicle and include all available condition information in the database 102 connected to host computer 101. At least one such system 107c may be configured to receive information from a non-franchised dealer or private party 201 desirous of listing a vehicle.

The host computer 101 may further be connected to a computer 202, for example operated by a financing organization or operated by the market-maker, executing various banking functions. By supporting such a connection, a buyer may secure financing for a purchase while executing the purchase through the host computer 101. The host computer 101 may be configured to facilitate a multi-party transaction involving the financing organization and a shipper, as well as the buyer, the seller and a local delivery dealer.

The host computer 101 may also further be accessible through remote workstations 203. Workstations 203 may be internet-connected computers available to consumers 204, who may be members of the general public, buyers for dealers, and other desiring to purchase vehicles using the system.

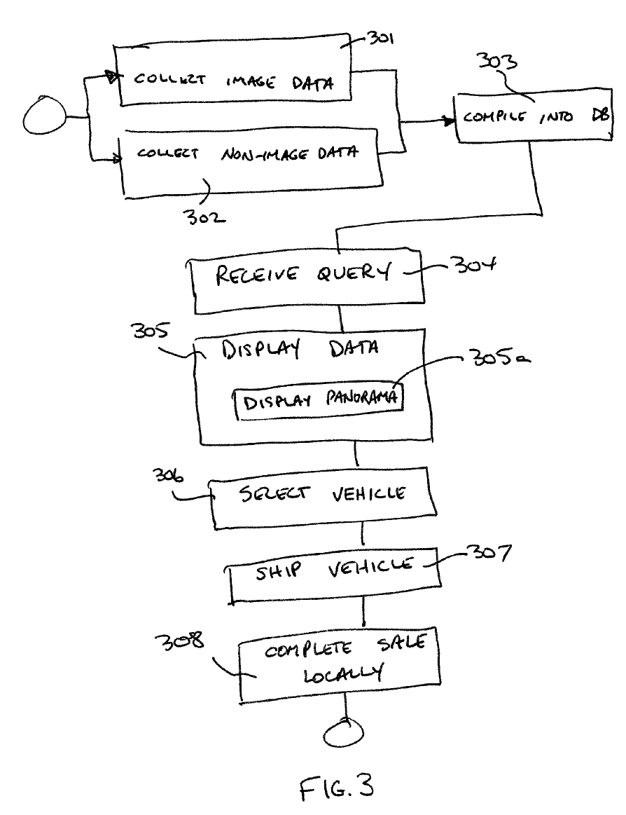

A method of executing a complete, successful sale is now described in connection with the flow diagram of FIG. 3.

In order to list a vehicle, image data is collected 301 and non-image data is collected 302. The data describing the listed vehicle are compiled into a searchable database 303. It is expected that these steps will be repeated for numerous vehicles.

A consumer enters a query, which is received 304 by the system. The system responds by displaying data 305 corresponding to vehicles matching the search criteria specified in the consumer's query. Displaying data corresponding to such vehicles may include displaying panoramic views 305a showing the exterior and interior of the vehicle circumnavigationally and in such detail that the consumer can discern any visual defects that they might have detected by visiting the actual location of the vehicle. When the consumer has found a satisfactory vehicle, the consumer then selects the vehicle for purchase 306, the system communicates with the seller, a local delivery dealer and a shipper to execute shipment of the vehicle 307, and the sale is completed locally 308, possibly using financing supplied through the system as described above.

Sales which fail to complete can be reversed by undoing the various steps that lead to the point where failure occurred. Alternatively, a dealer receiving a vehicle whose sale fails to complete can elect to retain that vehicle, pay for it, and add it to their own inventory to be re-listed or sold as desired.

The proposed internet-based market operates in real time, and thus reduces the market lag that exists today and reduces the revenue draw and expense of “holding” inventory for months, advertising expenses for dealers, shipping costs are transferred to the buyer not the seller, eliminates auction fees for the buyer and the seller, reduces damages and missing items from the vehicles (theft), and finds the “best” market to sell without guessing or relying on the whole market with the dealer's own region.

A market made as described can be an international market, with exporting becoming a large part of the total vehicle market. This process will eliminate the middlemen/brokers and directly connect sellers to buyers, and in some cases connect the seller directly with the retail consumer, while the “delivering” dealer will make a profit.

A market mode as described can support “bulk” wholesale transactions involving multiple dealers. For example, a dealer in a location experiencing a shortage of a hot SUV at the start of winter can search for, select, purchase, finance and ship the desired vehicles from locations having those vehicles without having to work out market logistics or go to multiple, remote auctions.

Some dealers will provide inspection/posting centers for the independent/non-franchised dealers to be able to obtain access for posting their own vehicles for sale on the site. Such a posting service can become a profit center, as well.

The data that is collected about the vehicles sold through the internet-based market may be retained and maintained as a historical record that can guide manufacturers and dealers about current vehicle values and market trends. The data record can also preserve for manufacturers or fleet companies more complete and detailed information concerning vehicle condition.

By searching and comparing across the data collected for the internet-based market, as well as the manufacturer's database or other private database, a dealer can better assess the market value of a vehicle offered in trade. The dealer can rapidly obtain information regarding the vehicle's original options, history and comparative market value. The comparative market value can reflect not only the immediate market price in the region in which the dealer is located, but can also reflect the high and lows globally, as well as trends over time. Market value can be presented as suitable charts, graphs and/or tables including as much detail as desired. A dealer appraising a vehicle for trade would receive a real-time data profile useful to make a correct assessment of the vehicle's true value when ultimately disposed of.

Opening an internet-based channel of commerce having the above-described features will improve the efficiency of the pre-owned vehicle market generally, and thus reduce the number of vehicle that go to auction houses, thereby helping the manufacturers and leasing companies shrink supply. Shrinking the supply of pre-owned vehicles will also improve the new car market. Providing the manufacturers with a higher resale value thru the auctions with a smaller supply available will increase the residual values and make for a stronger lease product in the new vehicle industry.

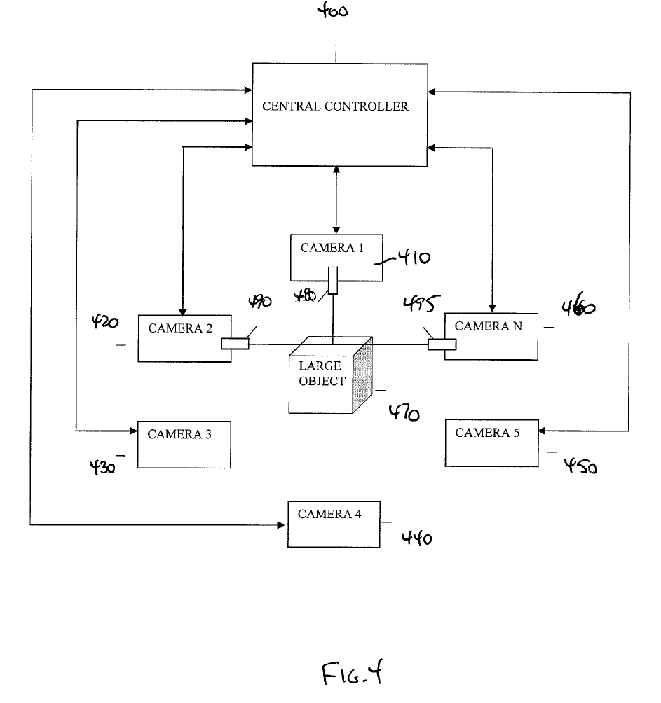

FIG. 4 is a block diagram generally illustrating one possible embodiment of a system for creating circumnavigational images according to aspects of some embodiments of the invention. The system may include a central controller 400, connected by means of a local area network to a plurality of image recording devices 410, 420, 430, 440, 450 and 460, which are arrayed in a precise configuration around a large object 470. The central controller 400 may be located in any suitable location, including as a separate device, e.g. within a portable computer, or incorporated in one of the image recording devices 410, 420, 430, 440, 450 and 460, and the connection may be made by any suitable communication system, e.g. an Ethernet local area network, a wireless network for example based on current WiFi standards, or an infrared network for example based on IrDA standards. Each camera is equipped with a laser light used to target the direction of view 480, 490, 495.

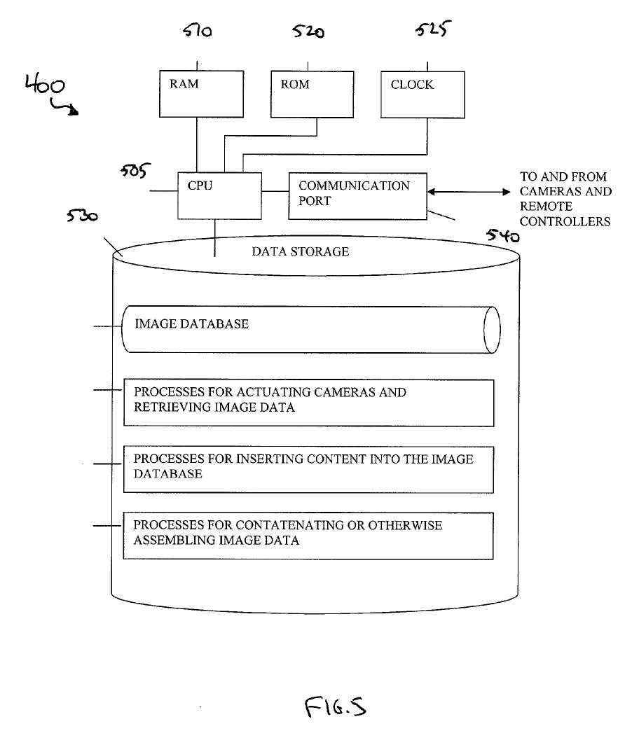

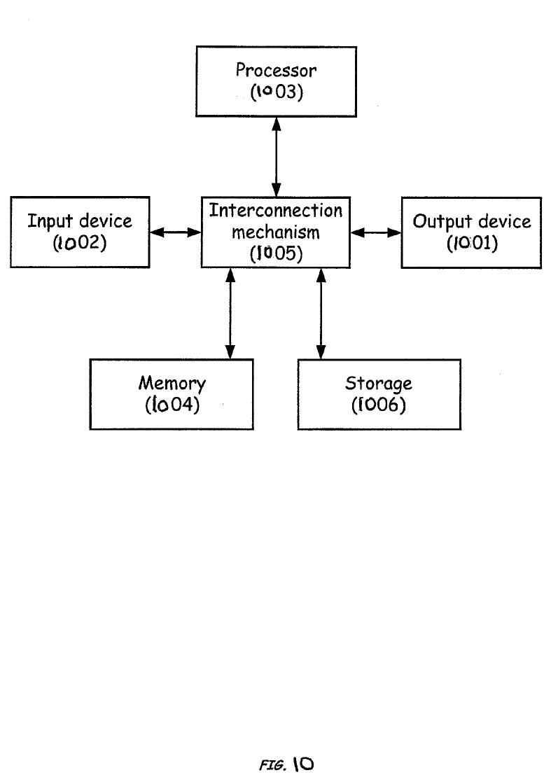

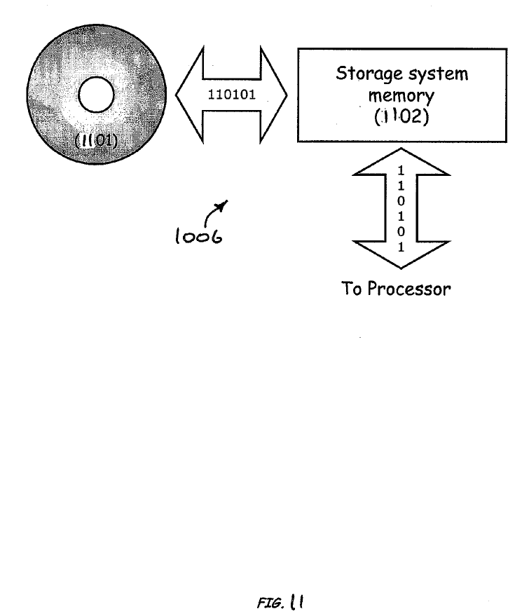

The block diagram of FIG. 5 defines an architecture of an illustrative central controller 400. As explained further, below, the architecture of the central controller 400 of the circumnavigational imaging system, as well as other computer-implemented components of the internet-based market system may be implemented generally as described in connection with FIGS. 10-11. The illustrative central controller 400 may include certain standard hardware components, such as a central processing unit (CPU) 505, a random access memory (RAM) 510, a read only memory (ROM) 520, a clock 525, a data storage device 530, and a communications port 540. The CPU 505 can be linked to each of the other listed elements, either by means of a shared data bus, or dedicated connections, as shown in FIG. 5.

The communications port 540 connects the central controller 400 to each image recording device 410, 420, 430, 440, 450, 460. The communications port 540 can include multiple communication channels for simultaneously establishing a plurality of connections.

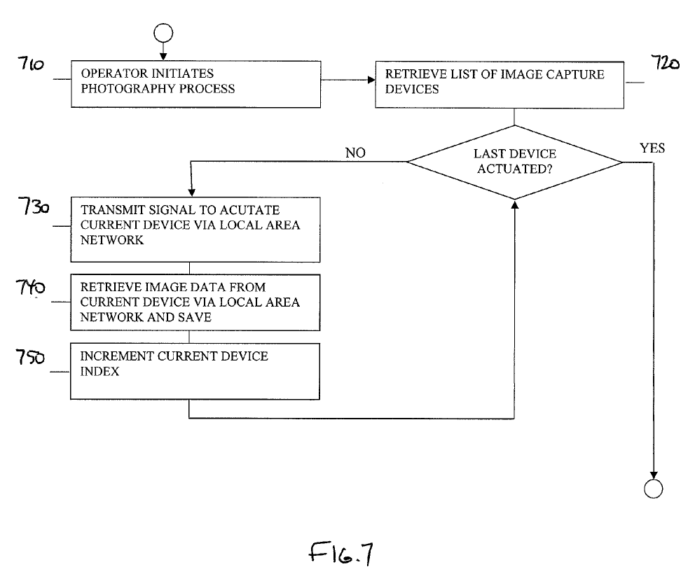

The ROM 520 and/or data storage device 530 are operable to store one or more instructions, discussed further below in conjunction with FIGS. 7, 8, and 9, which the CPU 505 is operable to retrieve, interpret and execute. For example, the ROM 520 and/or data storage device 530 can store processes to accomplish the actuation of image recording devices 410, 420, 430, 440, 450, 460, and the retrieval, composition, and delivery of images of the large object 470.

The architecture of FIG. 5 is particularly suitable for embodiment as a portable computer intended to be connected to the image recording devices 410, 420, 430, 440, 450 and 4360 and to other components of the internet-based market system through communications port 540 or any other suitable communications port (not shown) of the portable computer.

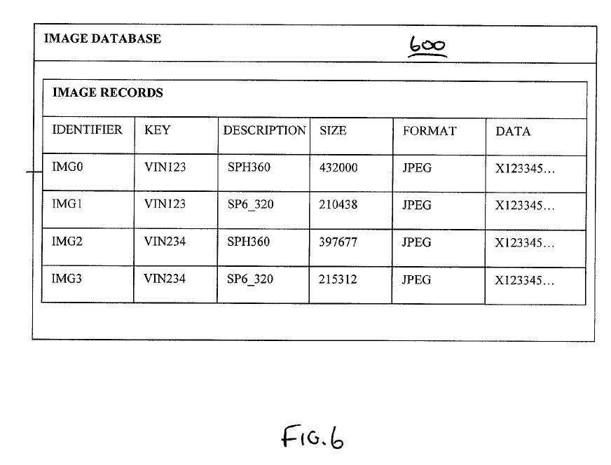

The image database 600 of FIG. 6 stores image data gathered by the image capture devices. The image database 600 can also store information used to associate image records with other descriptive information pertaining to the object they represent, for example a vehicle identification number used to link images of a particular vehicle to that vehicle's other condition information gathered from other databases, and the like, as described above. The image database 600 can be uploaded to a central database server component of the internet-based market system, as described above.

A process for actuating the image recording devices is now described in connection with FIG. 7. This exemplary process actuates a plurality of cameras and the resulting image data is then stored by the central controller 400.

When the photographic subject (FIG. 4, 470) has been positioned with respect to the image recording devices the operator may initiate 710 the image recording process by triggering any suitable input device, e.g. keyboard, mouse, special-purpose trigger hardware, etc., attached to the central controller 400. The central controller 400 shall then retrieve a list of available image recording devices 720 by polling devices linked to it via the local area network or by other means. The central controller shall then transmit a signal to each image recording device in turn 730 via the local area network or other means and subsequently retrieve and save the image data captured by that device 740. The central controller shall increment the index of the current image recording device 750 and repeat the process until all devices have been actuated and resulting images retrieved and stored.

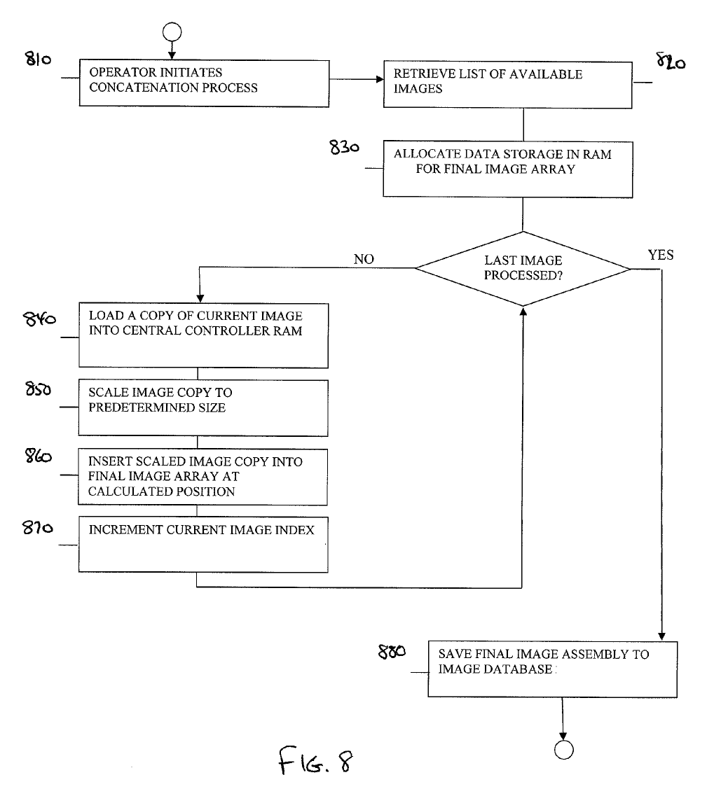

An exemplary process by which a plurality of individual images may be assembled into a final image configuration which may be appropriate for presentation as a circumnavigational image is now described in connection with FIG. 8. When a series of photographs have been created according to the Process for Actuating Image Recording Devices 700, the operator may initiate the Process for Concatenating Image Data 810 by triggering an input device attached to the central controller 400. The central controller 400 shall retrieve a list of available images 820 and then shall compute and allocate sufficient storage capacity within its RAM 510 to accommodate the concatenation of the available images 830. The central controller shall then load each of the available images into its RAM 840 and then scale the image to a predetermined size 850. The scaled image data shall then be inserted into the storage space allocated for the final concatenated image 860. The central controller shall increment the index of the current image and repeat the process until all available images have been concatenated into the storage allocated for the final image. The central controller shall then transfer the final concatenated image to the data storage database 600 according to the Process for Inserting Content into the Image Database 800.

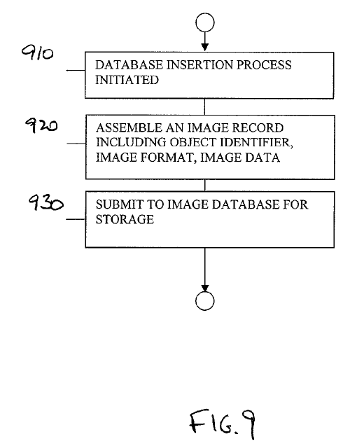

An exemplary process is now described in connection with FIG. 9 by which individual images may be inserted into the Image Database 600. The process may be initiated 910 by the Central Controller 400 in coordination with the Process for Concatenating Image Data. A record is prepared 920 which may contain a unique record identifier, a key identifying the object, description, image size, image format code, and the actual image data. This record is submitted to the Image Database 600 for storage as a discrete record 610.

Various aspects of embodiments according to the invention may be implemented on one or more computer systems. These computer systems may be, for example, general-purpose computers such as those based on Intel PENTIUM-type processor, Motorola PowerPC, Sun UltraSPARC, Hewlett-Packard PA-RISC processors, or any other type of processor. It should be appreciated that one or more of any type computer system may be used to perform any of the communication or data processing tasks described according to various embodiments of the invention. Further, any part of the system may be located on a single computer or may be distributed among a plurality of computers attached by a communications network.

A general-purpose computer system may be configured to perform any of the described functions including but not limited to collecting messages, storing messages, forwarding message and displaying or printing messages. It should be appreciated that the system may perform other functions, including network communication, and the invention is not limited to having any particular function or set of functions.

For example, various aspects of the invention may be implemented as specialized software executing in a general-purpose computer system 1000 such as that shown in FIG. 10. The computer system 1000 may include a processor 1003 connected to one or more memory devices 1004, such as a disk drive, memory, or other device for storing data. Memory 1004 is typically used for storing programs and data during operation of the computer system 1000. Components of computer system 1000 may be coupled by an interconnection mechanism 1005, which may include one or more busses (e.g., between components that are integrated within a same machine) and/or a network (e.g., between components that reside on separate discrete machines). The interconnection mechanism 1005 enables communications (e.g., data, instructions) to be exchanged between system components of system 1000.

Computer system 1000 also includes one or more input devices 1002, for example, a keyboard, mouse, trackball, microphone, touch screen, and one or more output devices 1001, for example, a printing device, display screen, speaker. In addition, computer system 1000 may contain one or more interfaces (not shown) that connect computer system 1000 to a communication network (in addition or as an alternative to the interconnection mechanism 1005.

The storage system 1006, shown in greater detail in FIG. 11, typically includes a computer readable and writeable nonvolatile recording medium 1101 in which signals are stored that define a program to be executed by the processor or information stored on or in the medium 1101 to be processed by the program. The medium may, for example, be a disk or flash memory. Typically, in operation, the processor causes data to be read from the nonvolatile recording medium 1101 into another memory 1102 that allows for faster access to the information by the processor than does the medium 1101. This memory 1102 is typically a volatile, random access memory such as a dynamic random access memory (DRAM) or static memory (SRAM). It may be located in storage system 1006, as shown, or in memory system 1004, not shown. The processor 1003 generally manipulates the data within the integrated circuit memory 1004, 1102 and then copies the data to the medium 1101 after processing is completed. A variety of mechanisms are known for managing data movement between the medium 1101 and the integrated circuit memory element 1004, 1102, and the invention is not limited thereto. The invention is not limited to a particular memory system 1004 or storage system 1006.

The computer system may include specially-programmed, special-purpose hardware, for example, an application-specific integrated circuit (ASIC). Aspects of the invention may be implemented in software, hardware or firmware, or any combination thereof. Further, such methods, acts, systems, system elements and components thereof may be implemented as part of the computer system described above or as an independent component.

Although computer system 1000 is shown by way of example as one type of computer system upon which various aspects of the invention may be practiced, it should be appreciated that aspects of the invention are not limited to being implemented on the computer system as shown in FIG. 10. Various aspects of the invention may be practiced on one or more computers having a different architecture or components that that shown in FIG. 10.

Computer system 1000 may be a general-purpose computer system that is programmable using a high-level computer programming language. Computer system 1000 may be also implemented using specially programmed, special purpose hardware. In computer system 1000, processor 1003 is typically a commercially available processor such as the well-known Pentium class processor available from the Intel Corporation. Many other processors are available. Such a processor usually executes an operating system which may be, for example, the Windows 95, Windows 98, Windows NT, Windows 2000 (Windows ME) or Windows XP operating systems available from the Microsoft Corporation, MAC OS System X operating system available from Apple Computer, the Solaris operating system available from Sun Microsystems, or UNIX operating systems available from various sources. Many other operating systems may be used.

The processor and operating system together define a computer platform for which application programs in high-level programming languages are written. It should be understood that the invention is not limited to a particular computer system platform, processor, operating system, or network. Also, it should be apparent to those skilled in the art that the present invention is not limited to a specific programming language or computer system. Further, it should be appreciated that other appropriate programming languages and other appropriate computer systems could also be used.

One or more portions of the computer system may be distributed across one or more computer systems coupled to a communications network. These computer systems also may be general-purpose computer systems. For example, various aspects of the invention may be distributed among one or more computer systems configured to provide a service (e.g., servers) to one or more client computers, or to perform an overall task as part of a distributed system. For example, various aspects of the invention may be performed on a client-server or multi-tier system that includes components distributed among one or more server systems that perform various functions according to various embodiments of the invention. These components may be executable, intermediate (e.g., IL) or interpreted (e.g., Java) code which communicate over a communication network (e.g., the Internet) using a communication protocol (e.g., TCP/IP).

It should be appreciated that the invention is not limited to executing on any particular system or group of systems. Also, it should be appreciated that the invention is not limited to any particular distributed architecture, network, or communication protocol.

Various embodiments of the present invention may be programmed using an object-oriented programming language, such as SmallTalk, Java, C++, Ada, or C# (C-Sharp). Other object-oriented programming languages may also be used. Alternatively, functional, scripting, and/or logical programming languages may be used. Various aspects of the invention may be implemented in a non-programmed environment (e.g., documents created in HTML, XML or other format that, when viewed in a window of a browser program, render aspects of a graphical-user interface (GUI) or perform other functions). Various aspects of the invention may be implemented as programmed or non-programmed elements, or any combination thereof.

Variations of the foregoing aspects of the invention are particularly useful in other applications requiring vehicle history information, such as in insurance applications. Because the imaging equipment and process is both inexpensive and economical of time, it may be included in such locations and used at such times as a vehicle owner may customarily bring the vehicle without special effort. For example, it may be integrated with emissions and safety inspection stations, installed in body shops, and used in other common locations at which vehicles are taken and either inspected or modified. Those stations, shops and the like may also collect text-based history, such as emissions reports. By doing so, a continuous history of a vehicle, including images taken at regular or irregular intervals can be collected and correlated using the aspects of the invention described above. When an insurer or other person contemplating a transaction involving the vehicle requires, they may then access the combined database of vehicle information to obtain the history and most recent condition, in a similar fashion to a buyer in the sales or auction systems described.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A method of making a market in used vehicles, comprising:
collecting image data depicting a vehicle for sale in sufficient detail that visual imperfections are evident in the images when displayed using scan and zoom functions;
collecting non-image vehicle data further characterizing the vehicle for sale;
compiling the collected data into a searchable database;
receiving from a customer a query defining a desired vehicle;
displaying data to the customer responsive to the query;
selecting a vehicle responsive to an input by the customer;
shipping the selected vehicle from a dealer remote from the customer to a dealer local to the customer; and
completing a transaction involving the vehicle at the dealer local to the customer.

2. The method of claim 1, further comprising:
during the act of collecting image data, capturing a plurality of images depicting exterior features of a vehicle; and
during the act of displaying data, displaying the plurality of images as a panorama of the exterior features of the vehicle.

3. The method of claim 2, further comprising:
navigating a user viewpoint over the panorama so as to simulate moving around the vehicle to examine substantially all of the exterior thereof.

4. The method of claim 3, further comprising:
providing the image data with sufficient resolution to permit the customer to identify and examine ordinarily visible wear and accident damage to the exterior thereof.

5. The method of claim 4, further comprising:
navigating the user viewpoint to zoom in on a selected point in the panorama.

6. The method of claim 1, further comprising:
during collecting non-image data, associating condition data specific to a particular vehicle using a unique vehicle identifier.

7. The method of claim 6, wherein the unique vehicle identifier is a vehicle identification number (VIN).

8. The method of claim 6, wherein the unique vehicle identifier is a hull identification number (HIN).

9. The method of claim 6, further comprising:
combining condition data obtained from one or more sources taken from the list including manufacturer data, dealer data, insurance data, police records, registration records and owner-input data.

10. The method of claim 9, further comprising:
restricting selecting to fewer than all vehicles conforming to the input by the customer.

11. The method of claim 1, further comprising:
placing a plurality of image capture devices around the vehicle exterior, including at least one pair of adjacent image capture devices; and
controlling the plurality of image capture devices with a central processor.

12. The method of claim 11, further comprising:
computing matching image points in images produced by the pair of adjacent image capture devices; and
joining the images produced by the pair of adjacent image capture devices.

13. The method of claim 1, further comprising:
during the act of collecting image data, capturing a plurality of images depicting interior features of a vehicle; and
during the act of displaying data, displaying the plurality of images as a panorama of the interior features of the vehicle.

14. The method of claim 13, wherein capturing further comprises:
removably mounting an image capture device centrally within the interior of the vehicle;
rotating the image capture device while capturing a substantially continuous sequence of images; and
panning the image capture device while capturing plural sequences of images, whereby
substantially all features of the vehicle interior appear in the captured images.

15. The method of claim 14, wherein the features of the vehicle interior appearing in the captured images include depictions of wear to surfaces receiving wear during normal use.

16. The method of claim 15, wherein the surfaces include at least one of: vehicle controls, vehicle seating and vehicle flooring.

17. A method of documenting vehicle condition, comprising:
collecting image data depicting a vehicle whose condition is to be documented in sufficient detail that visual imperfections are evident in the images when displayed using scan and zoom functions;
collecting non-image vehicle data further characterizing the vehicle; and
compiling the collected data into a searchable database.

18. The method of claim 17, further comprising:
receiving a query defining a vehicle whose documented condition is to be examined;
retrieving data from the searchable database; and
displaying data retrieved from the searchable database responsive to the query.

19. The method of claim 17, further comprising:
performing the act of collecting image data both before and after a change in vehicle condition.

20. The method of claim 19, wherein the change in vehicle condition includes a change in insurance coverage.

21. The method of claim 19, wherein the change in vehicle condition includes infliction of damage to the vehicle.

22. The method of claim 19, wherein the change in vehicle condition includes a repair to the vehicle.

23. The method of claim 19, further comprising performing at least one of collecting image data and collecting non-image data during the ordinary course of at least one of vehicle use, inspection and repair.
